(19) United States
(12) Patent Application Publication
(10) Pub. No.: US 2007/0159717 A1
(43) Pub. Date: Jul. 12, 2007

(54) Hard-Disk Drive Device

(75) Inventors: Kazuto Miyajima, Kyoto (JP); Takehito Tamaoka, Kyoto (JP); Hiroomi Ogawa, Ichinomiya-shi, Aichi (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: NIDEC CORPORATION, Kyoto (JP)

(21) Appl. No.: 11/163,634

(22) Filed: Oct. 25, 2005

(30) Foreign Application Priority Data
Oct. 25, 2004 (JP) 2004-308991
Oct. 25, 2005 (JP) 2005-310560

(51) Int. Cl. G11B 17/02; G11B 5/016

(52) U.S. Cl. 360/99.12; 360/99.05

(57) ABSTRACT

In a low-profile disk drive device, the hard-disk carrying face of the spindle motor hub is finished to leave a spiral-patterned cutting track. Leaving the spiral-patterned cutting track increases the roughness of the carrying face, but seen in terms of the cutting-track hill portions themselves the surface unevenness is reduced. Because the disk is supported on the hill portions, warpage in the disk is attenuated.

### BACKGROUND OF THE INVENTION

1. Technical Field

The present invention relates to methods of manufacturing the hub component of a spindle motor, and to hard-disk drives in which such hubs are installed. In particular the invention relates to methods of manufacturing hubs that are built into slim, miniature hard-disk drives in which the thickness of the recording disks is less than 0.5 mm.

2. Description of the Related Art

In hard-disk drives, miniaturization and flattening has been pursued for a number of years now. This pursuit has entailed the need to slenderize the disks onto which information is recorded. For example, disks that were 1 mm or more in thickness in hard-disk drive devices 3.5 inches in size have become less than 0.4 mm in thickness in hard-disk drives that are 1 inch in size.

As the thickness of a sheet material is narrowed, its stiffness drops abruptly, making the material susceptible to bending. This means that on account of slight irregularities in the disk-carrying surface warpage will occur in the disk. Because the recording density on disks is increased attendant on their miniaturization, the tolerance for warpage in the recording face lowers, making it necessary to pay scrupulous attention to the machining of the disk-carrying surfaces.

To answer this demand, disk-carrying surfaces to date have been machined to an as-smooth-as-possible finish by, for example, an exacting facing or similar operation. Despite such machining operations, however, bumps can remain in places on the machined surface, which proves to be a causative source of errors in a hard-disk drive device's reading and writing of information.

### BRIEF SUMMARY OF THE INVENTION

In a hard-disk drive device of the present application, in finish-machining the disk-carrying face, facing conditions are selected to deliberately leave a cutting track in the surface; furthermore, the cutting track is rendered so as to form a spiral while closely covering the disk-carrying face, just like the grooves in a vinyl record. Though choosing such facing conditions leads to intensified roughness average Ra and maximum roughness Rz of the disk-carrying face, the machining is done selecting conditions by which the face turns out rough.

In situations in which a smooth flat surface is required, with conventional methods the cutting depth and diametrical traveling velocity of the machining tool have been chosen small, to shave the surface incrementally. Although a smooth flat cutting face can certainly be obtained in this way, minute protrusions will form in places. This is presumed to be because some of the cutting dust gets caught between tip of the tool and the cutting face, where, as a result of rubbing on the work surface, it turns into bumps that remain there.

The facing operation conditions leaving a spiral-patterned cutting track are such that, with the depth of cut enlarged to a certain extent, the cutting tool tip is constantly shifted by exactly the proper amount, whereby the tool tip continuously shaves a portion of the workpiece that is always new. Under these conditions, occurrences of cutting dust getting caught in between the tool and the machining face do not arise.

Following the machining operation, because a ruled cutting track is left, a carrying face is produced in which the amount by which the ridge portions of the cutting track protrude is relatively regular. Because hard disks come into contact with the spindle-motor hub on the ridge portions of the carrying face, even with disks of relatively low compatibility with the hub material, warpage does not occur.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

FIG. 1 is a section view of a hard-disk drive representing one embodiment of the present invention;

FIG. 2 is an illustrative diagram depicting the configuration of a clamping device;

FIGS. 3 through 6 are diagrams representing a method of manufacturing a rotor hub;

FIG. 7 is section and plan views of the rotor hub, indicating the location for measuring the surface profile of the hub's recording-disk carrying face;

FIG. 8 is a graph of the surface profile of the recording-disk carrying face; and

FIG. 9 is a photograph of surface along the recording-disk carrying side of the hub.

### DETAILED DESCRIPTION OF THE INVENTION

An embodiment of the present invention is explained with reference to figures. In the explanation, wording such as “up,” “down,” “left” and “right” is merely used to indicate directions within the diagram, and does not limit directionality in implementing the invention.

### (1) Hard-Disk Drive Device Involving the Present Invention

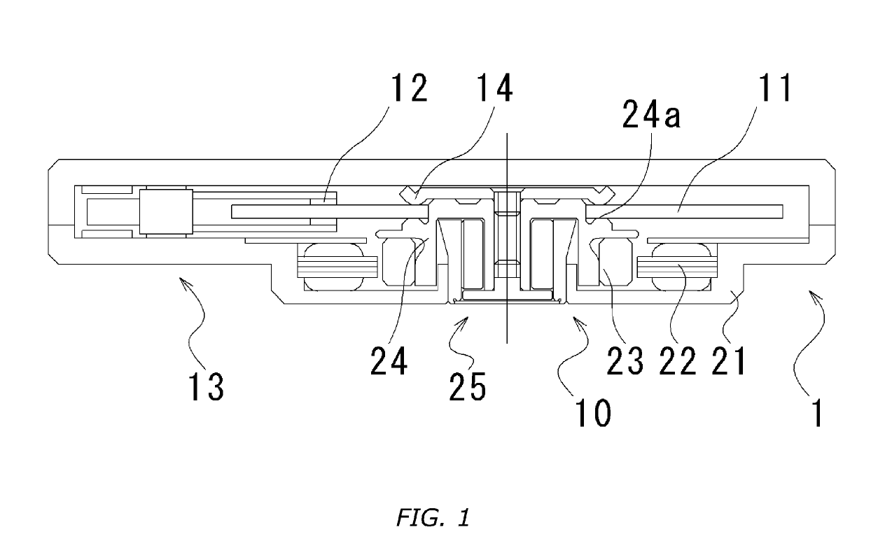

FIG. 1 is a sectional diagram of a hard disk drive depicting an embodiment of the present invention. The hard disk drive 1 comprises a recording disk 11 for storing information, a head 12 for reading information from and writing information onto the recording disk, an actuator 13 for moving the head, and a spindle motor 10 for spinning the disk.

A base plate 21, which forms the base of the spindle motor 10, constitutes a portion of the disk drive 1 chassis. A stator 22 furnished with a plurality of coils is attached to the base plate 21. At the same time, a rotor hub 24 is supported by a dynamic pressure bearing 25 so as to be freely rotatable with respect to the base plate 21. An annular rotor magnet 23 is attached to a portion of the rotor hub 24 radially opposing the inner circumferential surface stator 22. The stator 22, the rotor magnet 23, and the dynamic bearing 25 constitute a rotary drive mechanism that rotationally drives the rotor hub 24.

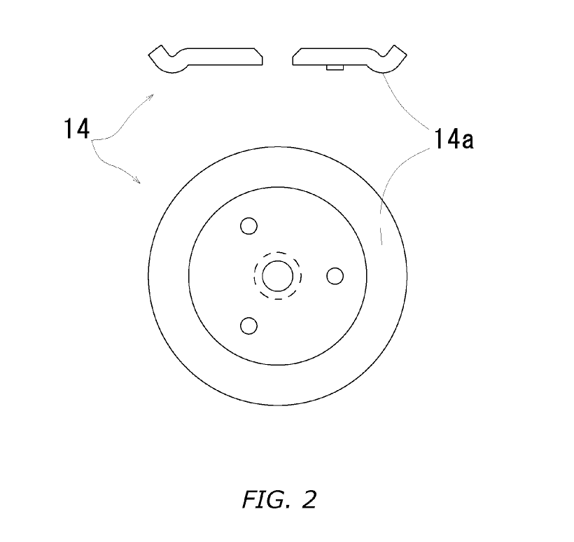

A flat surface 24a, approximately perpendicular to the motor shaft, is formed on the rotor hub 24. The recording disk 11 is mounted on that flat surface 24a. Furthermore, the recording disk 11 is pressed onto the flat surface 24a by a clamp 14. As depicted in FIG. 2, the clamp 14 is approximately discoid, and a contact surface 14a thereof is also annular. The disk 11 can therefore be uniformly pressed upon.

The disk 11 mounted on the rotor hub has a diameter of one inch and a thickness of 0.4 mm. An extremely thin layer of magnetic material is formed on the surface of the disk, which is made of glass, superficially finished smooth and flat. Such a structure results in a disk bending stiffness approximately equal to the disk bending stiffness of a glass disk.

The Young's modulus of the glass is 86 GPa. Although the disk can be made of other materials, the Young's modulus of the disk material should be equal or grater than 60 GPa. If the modulus of elasticity is smaller than 60 GPa, warping of the disk cannot be sufficiently inhibited even using a hub of the present invention.

### (2) Rotor Hub Machining Process

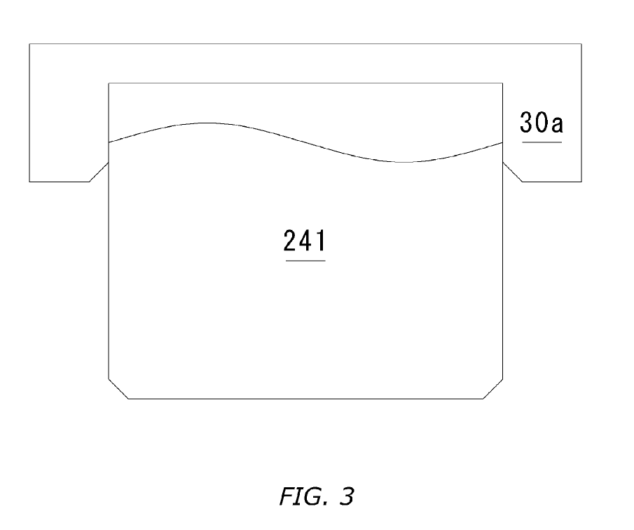

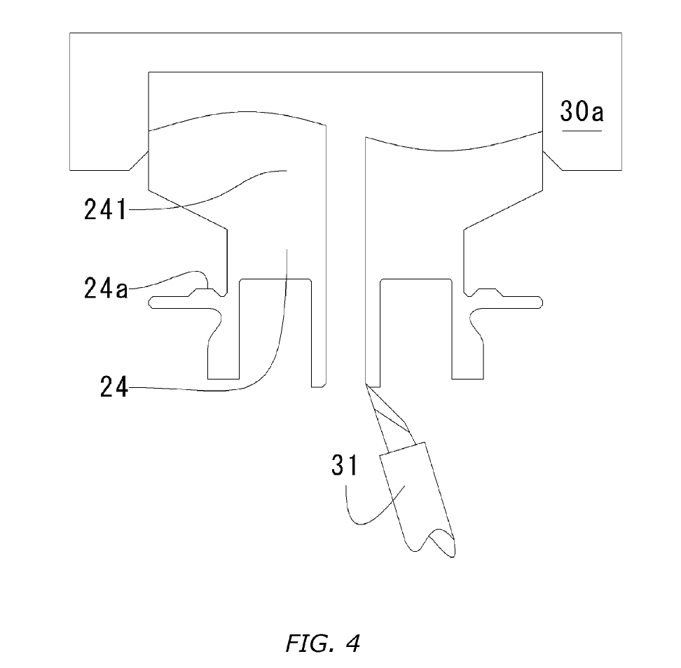

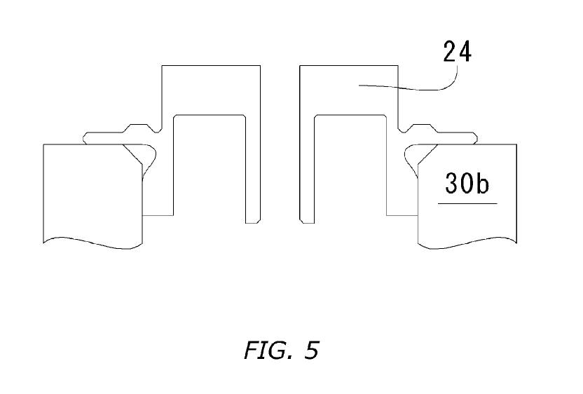

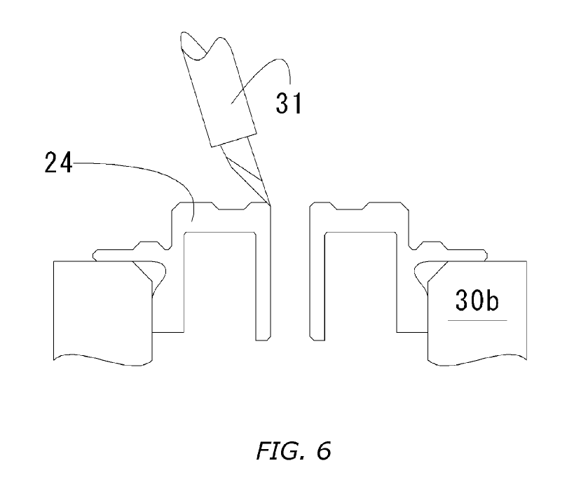

FIGS. 3 through 6 depict a method of manufacturing a rotor hub mounted on the FIG. 1 hard-disk drive device of the present invention. The rotor hub 24 is machined using a lathe. Machining of the rotor hub 24 is accomplished by lathe facing of a blank 241. That is, the blank 241 is first held in a rotatable first chuck 30a (FIG. 3). Next, using a bit 31, the lower side is faced and then the upper side is faced to form the major portion of the rotor hub 24 (FIG. 4). The disk carrying face is also formed at the time the upper side is faced. Thereafter, the rotor hub 24 is removed from the first chuck 30a, held in a second chuck 30b, and cut away from the blank 241 (FIG. 5). Furthermore, the separated portion of the rotor hub 24 is completed by further machining using the bit 31 (FIG. 6).

It will be appreciated that when increasing surface accuracy or forming rotor hubs with shapes which are extremely difficult to machine, the rough shape of the hub may be formed first by facing or by another method, and subsequently forming the shape of the disk carrying face, fine portions, etc. using the method of the present invention.

The diameter of the rotor hub is approximately 10 mm; the outer diameter of the hub carrying face is approximately 7.5 mm; and the inner diameter of the hub carrying face is approximately 6.5 mm. A ferritic free-cutting stainless steel, widely used for spindle motor hubs, was utilized as the rotor hub material.

It should be noted that in addition to the above-mentioned material, martensite and austenite stainless steel, aluminum and alloys thereof, brass, copper alloys, various steel materials, and materials which are cuttable and of appropriate mechanical strength may be used as rotor hub materials.

### (3) Facing Operation

Because the conditions for the facing operation employed to form spiral-shaped cutting tracks will differ depending on hub material, machining tool (bit), surface treatment, and the like, they are difficult to specify categorically. If the bit feed speed is slow, the spiral configuration will become indistinct, whereas if too fast, the cutting track will become disturbed, such that a spiral will not form. In such cases, moreover, the roughness frequently exceeds upper limits established for Ra and Rz. Furthermore, the depth of cut of the bit also has an effect. Leaving a spiral cutting track, however, is of itself by no means difficult; machining conditions can be discovered through several iterations of trial and error. When so doing, appropriate moving speeds should be searched for under the condition of a fixed speed for moving the bit from the inner circumferential edge to the outer circumferential edge in the radial direction.

In the present invention, the target arithmetic average roughness (Ra) is set at 1.6 μm, and the maximum height (Rz) at 6.3 μm. These are values that indicate a mitigation by as much as one fourth compared to the arithmetic average roughness (Ra) of less than or equal to 0.4 and maximum height (Rz) of less than or equal to 1.6 that has been the target of conventional cutting methods. Moreover, facing conditions for leaving a clear cutting track generally require less time for machining compared to finishing of a flat surface. The present invention therefore contributes to productivity improvements.

### (4) Results

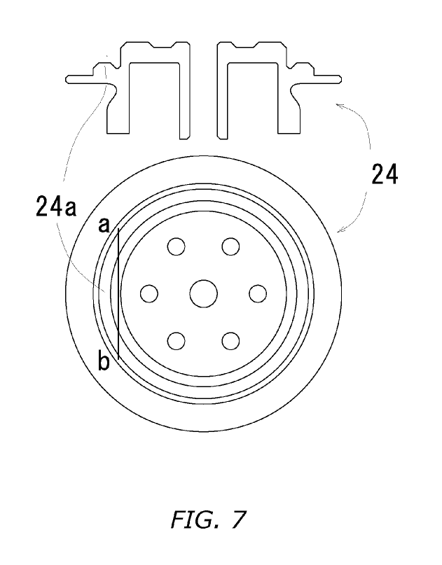

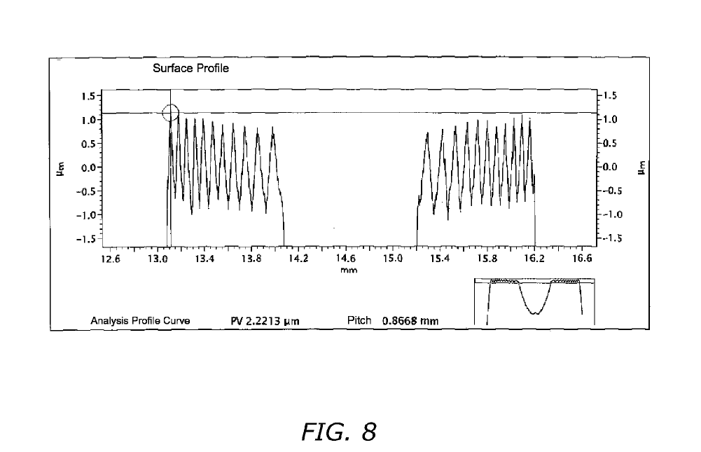

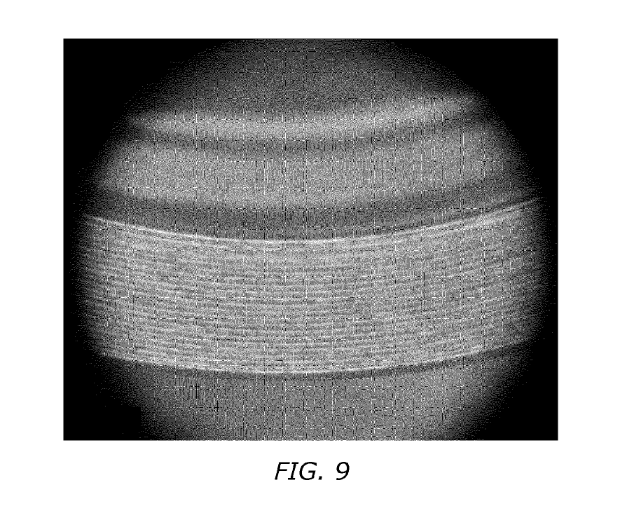

A cross-section of a rotor hub 24 recording disk carrying face 24a finished by machining under these conditions is shown in FIG. 8; a photograph of the machined product is shown in FIG. 9. The positions measured in the section are between “a” and “b” in FIG. 7. In FIG. 8, the vertical axis is magnified by approximately 200× with respect to the horizontal axis.

In FIG. 8, hills and valleys are regularly repeated on the recording disk carrying face, and hill heights are approximately uniform. The difference between the recording disk carrying face 24a average hill peak height and the highest hill height is about 0.2 μm. That is, by focusing only on the peak portion of the hills, the view can be taken that the degree of flatness is approximately the same as the arithmetic average roughness Ra of 0.4 that has traditionally been targeted.

At the same time, the average roughness of rotor hub recording disk carrying faces in conventional products is smaller. However, when disk flatness was checked after actually installing a disk on a hub and affixing it with the clamp, some disks with considerable warpage were found. The reason for the occurrence of such deformations is thought to lie in the formation of localized bumps. It is hypothesized, in other words, that under conditions of gradual cutting with the goal of flattening, phenomena such as lodging of cutting dust between the bit and the object being machined, causing the bit to jump, or adhesion of cutting particles to surfaces, etc. may occur.

Because such bumps, even if only temporarily formed, are immediately cut off by the bit, they persist only relatively infrequently. With respect to prior product carrying faces, looking at a section such as FIG. 8, for example, it is very difficult to capture such bumps, and the aforementioned hypothesis is difficult to prove. However, the fact that such deformations are resolved by the structure of the present invention does suggest the correctness of the hypothesis.

Although difficult to confirm from FIG. 9, it can be understood that as one follows a cutting track in the circumferential direction, individual cutting tracks shift position in the radial direction, although only by a slight amount at a time. That is, the cutting track as a whole forms the shape of a tightly wound spiral.

It should be understood that the pitch in the diametric direction of this spiral-shaped cutting track and the height of the hills and depth of the valleys thereof changes according to machining conditions. The appearance of cutting tracks formed on the recording disk carrying face 24a also differs.

As a result of implementing the present invention, the height of the hills in the carrying face unevenness is set at a fixed height that is up to the level at which disk distortion will not occur, reducing recording-disk deformations. As a result, errors during reading and writing of information to the hard disk drive device are reduced.

### (5) Other Embodiments

Embodiments of the present invention are not bound by the above embodiment; several variations are possible. For example, the blank could be formed by pressing or die-casting, then faced as set forth in the present invention for the finishing process. A flat surface of a conventional type could also be first formed under slow tool feed conditions and then finished by facing under conditions at which a spiral cutting track is formed, so as to be like the product of the present invention. Tool feed speed is not limited to being fixed from the inner edge to the outer edge. Variations are possible such as reducing the feed speed as the outer edge is approached.

With respect to the recording of magnetic information, drive capacity can be increased by adopting a perpendicular magnetic recording system. In this case, recording density will be 200 Mbit/mm² or greater, accompanied by a further reduction in tolerated hard disk deformation. Such a hard disk drive device can be economically manufactured by adopting a configuration of the present invention.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A hard-disk drive device comprising:
a hard disk composed of a discoid base made of a material whose Young's modulus is equal to or greater than 60 GPa, and a magnetic layer formed covering the base, said hard disk in total being thinner than 0.5 mm;
a hub having a carrying face surrounding the hub center axis, for carrying said hard disk, said carrying face being finished by a facing operation such that a circumferentially extending cutting track forming a spiral centered on the center axis and covering the entire surface of said carrying face is produced in said carrying face;
a spindle motor composed of said hub and a mechanism for rotationally driving said hub;
a clamp having an annular contact surface for contact with the side of said hard disk opposite said carrying face, said clamp therein for pressing, via said contact face, upon said hard disk in the direction toward said carrying face, to anchor said hard disk; and
a magnetic head for writing magnetic data onto or reading magnetic data from said hard disk.

2. A hard-disk drive device as set forth in claim 1, wherein said cutting track is formed joining the inner circumferential edge to the outer circumferential edge of said carrying face.

3. A hard-disk drive device as set forth in claim 1, wherein the maximum height roughness Rz of said carrying face after having undergone said finishing operation is between 0.8 μm and 6.3 μm inclusive.

4. A hard-disk drive device as set forth in claim 2, wherein the maximum height roughness Rz of said carrying face after having undergone said finishing operation is between 0.8 μm and 6.3 μm inclusive.

5. A hard-disk drive device as set forth in claim 1, wherein the arithmetic average height roughness Ra of said carrying face after having undergone said finishing operation is between 0.2 μm and 1.6 μm inclusive.

6. A hard-disk drive device as set forth in claim 2, wherein the arithmetic average height roughness Ra of said carrying face after having undergone said finishing operation is between 0.2 μm and 1.6 μm inclusive.

7. A hard-disk drive device as set forth in claim 3, wherein the arithmetic average height roughness Ra of said carrying face after having undergone said finishing operation is between 0.2 μm and 1.6 μm inclusive.

8. A hard-disk drive device as set forth in claim 4, wherein the arithmetic average height roughness Ra of said carrying face after having undergone said finishing operation is between 0.2 μm and 1.6 μm inclusive.

9. A hard-disk drive device as set forth in claim 1, wherein said carrying face is finish-machined by facing said carrying face with a cutting tool, in a state in which said hub is being rotated relative to the cutting tool, and the separation between the cutting tool and the hub center axis is either increased or decreased at a constant speed.

10. A hard-disk drive device as set forth in claim 2, wherein said carrying face is finish-machined by facing said carrying face with a cutting tool, in a state in which said hub is being rotated relative to the cutting tool, and the separation between the cutting tool and the hub center axis is either increased or decreased at a constant speed.

11. A hard-disk drive device as set forth in claim 3, wherein said carrying face is finish-machined by facing said carrying face with a cutting tool, in a state in which said hub is being rotated relative to the cutting tool, and the separation between the cutting tool and the hub center axis is either increased or decreased at a constant speed.

12. A hard-disk drive device as set forth in claim 4, wherein said carrying face is finish-machined by facing said carrying face with a cutting tool, in a state in which said hub is being rotated relative to the cutting tool, and the separation between the cutting tool and the hub center axis is either increased or decreased at a constant speed.

13. A hard-disk drive device as set forth in claim 5, wherein said carrying face is finish-machined by facing said carrying face with a cutting tool, in a state in which said hub is being rotated relative to the cutting tool, and the separation between the cutting tool and the hub center axis is either increased or decreased at a constant speed.

14. A hard-disk drive device as set forth in claim 6, wherein said carrying face is finish-machined by facing said carrying face with a cutting tool, in a state in which said hub is being rotated relative to the cutting tool, and the separation between the cutting tool and the hub center axis is either increased or decreased at a constant speed.

15. A hard-disk drive device as set forth in claim 1, wherein the recording density of magnetic information recorded by said hard disk is 200 Mbit per square millimeter.

16. A hard-disk drive device as set forth in claim 2, wherein the recording density of magnetic information recorded by said hard disk is 200 Mbit per square millimeter.

17. A hard-disk drive device as set forth in claim 3, wherein the recording density of magnetic information recorded by said hard disk is 200 Mbit per square millimeter.

18. A hard-disk drive device as set forth in claim 4, wherein the recording density of magnetic information recorded by said hard disk is 200 Mbit per square millimeter.

19. A hard-disk drive device as set forth in claim 5, wherein the recording density of magnetic information recorded by said hard disk is 200 Mbit per square millimeter.

20. A spindle motor hub for a hard-disk drive device employing a hard disk of less than 0.5 mm total thickness, the hard disk composed of a discoid base made of a material whose Young's modulus is equal to or greater than 60 GPa, and a magnetic layer formed covering the base, the hub having a carrying face surrounding the hub center axis, for carrying the hard disk clamped by a clamp against the carrying face, said carrying face finished by a facing operation such that a circumferentially extending cutting track forming a spiral centered on the center axis and covering the entire surface of said carrying face is produced in said carrying face.
